(19) United States
(12) Patent Application Publication
(10) Pub. No.: US 2016/0162268 A1
(43) Pub. Date: Jun. 9, 2016

(54) SERIAL PROTOCOL COMMUNICATIONS BETWEEN A COMPUTERIZED USER DEVICE AND A BATTERY MODULE

(71) Applicant: NEC Energy Solutions, Inc., Westborough, MA (US)

(72) Inventors: Matthew F. Bush, Tyngsboro, MA (US); Steven L. Rosen, Foxboro, MA (US)

(21) Appl. No.: 14/562,944

(22) Filed: Dec. 8, 2014

(51) Int. Cl. G06F 9/445; H04L 12/40

(52) U.S. Cl. CPC G06F 8/60; G06F 9/445; H04L 12/40

(57) ABSTRACT

Systems and methods that provide for efficient communication between a computerized user device and a battery module using a serial communication protocol. The systems and methods employ a bootloader program that can be executed in response to commands issued by the computerized user device using the serial communication protocol, thereby allowing one or more selected firmware programs to be downloaded into nonvolatile memory within the battery module and subsequently executed for performing functions relating to design, manufacture, testing, and/or maintenance of the battery module for a range of target battery applications.

### TECHNICAL FIELD

The present application relates generally to systems and methods of communicably connecting a computerized user device to a battery module, and more specifically to systems and methods of efficient communication between a computerized user device and a battery module using a serial communication protocol, such systems and methods being configurable for use in target applications including, but not limited to, design validation, calibration, simultation testing, and/or performance monitoring of the battery module.

### BACKGROUND

In recent years, batteries have been increasingly employed in target applications ranging from laptop computers, smartphones, and other low power battery applications to electrical grid, backup power, and other high power battery applications. For example, such batteries can include rechargeable batteries such as nickel-cadmium batteries, nickel-metal-hydride batteries, lithium-ion batteries, etc. in order to allow users to obtain specific characteristics of such rechargeable batteries, as well as predict remaining battery life and recharge times, the rechargeable batteries are frequently deployed in smart battery configurations, winch allow the batteries' present capacity and charging information to be provided to and/or monitored by a host computer, a battery analyzer, or a battery charger.

A conventional smart battery configuration can include a host computer, a smart battery, a battery charger, and a bus communicably connecting the host computer, the smart battery, and the battery charger to one another. The smart battery is typically configured as a battery pack or module including a plurality of battery cells and associated circuitry operative to provide information pertaining to at least the state-of-charge (SOC) of the battery module. The smart battery can provide such information over the bus, in conformance with the SMART BATTERY DATA SPECIFICATION, Revision 1.1, Dec. 11, 1998, or latest revision. The bus is typically configured as a system management bus (SMBus) for providing communication and signaling between the devices connected to the SMBus, in conformance with the SYSTEM MANAGEMENT BUS (SMBUS) SPECIFICATION, Version 2.0, Aug. 3, 2000, or latest revision.

Although the conventional smart battery configuration described herein has been widely employed for managing smart batteries within laptop computers, smartphones, and other portable computerized devices, such a conventional smart battery configuration has drawbacks in that it is generally incapable of providing the information and/or level of control needed in the design, manufacture, testing, and/or maintenance of battery modules for a number of target battery applications. It would therefore be desirable to have systems and methods of efficient communication between a computerized user device and a battery module that can avoid at least some of the drawbacks and limitations of the conventional smart battery configuration.

### SUMMARY

In accordance with the present application, systems and methods are disclosed that provide for efficient communication between a computerized user device and a battery module using a serial communication protocol. The disclosed systems and methods employ a bootloader program that can be executed in response to commands issued by the computerized user device using the serial communication protocol, thereby allowing selected firmware programs to be downloaded into nonvolatile memory within the battery module and subsequently executed for performing desired functions relating to design, manufacture, testing, and/or maintenance of the battery module for a range of target battery applications.

In one aspect, a system for communicably connecting a computerized user device to a battery module includes at least one battery module having one or more managed battery cells, a serial communication port interface, and a battery manager. The battery manager includes a battery manager controller, which, in turn, includes a battery manager processor, a nonvolatile (NV) battery manager memory, and a read-write (R-W) battery manager memory. In an exemplary aspect, the computerized user device is a host computer containing the battery module. In an alternative exemplary aspect, the battery module is external to and separate from the computerized user device. The NV battery manager memory is operative to store at least a bootloader program and one or more firmware application programs. In an exemplary aspect, the battery manager processor is operative to execute a selected application program out of the NV battery manager memory for performing design validation, calibration, simulation testing, and/or performance monitoring of the battery module. In an alternative exemplary aspect, the battery manager processor is operative to execute the selected application program out of the R-W battery manager memory for performing such design validation, calibration, simulation testing, and/or performance monitoring of the battery module. The serial communication port interface is configured to allow the battery module to participate in a two-way, half duplex communication with the computerized user device over a point-to-point communication link.

In an exemplary mode of operation, the computerized user device, in response to at least one user input, can execute a computer program out of its system memory to select a firmware program, such as a firmware application program, stored in the system memory, and to send at least one command over the point-to-point communication link to the battery module using the serial communication protocol. In response to the command from the computerized user device, the battery manager processor can execute the bootloader program out of the NV battery manager memory to download the selected firmware application program over the point-to-point communication link from the system memory of the computerized user device to the NV battery manager memory of the battery manager controller. The battery manager processor can further execute the selected application program out of the NV battery manager memory for performing design validation, calibration, simulation testing, and/or performance monitoring of the battery module.

By providing a battery module with a battery manager processor and a bootloader program that is responsive to commands issued by a computerized user device using a serial communication protocol, including, but not limited to, commands for directing the bootloader program to download a selected firmware program from the computerized user device over a point-to-point communication link to the battery module, and to subsequently execute the selected program at the battery module, a user can advantageously perform desired functions relating to the design, manufacture, testing, and/or maintenance of the battery module for a range of target battery applications.

Other features, functions, and aspects of the invention will be evident from the Detailed Description that follows.

### BRIEF DESCRIPTION OF THE DRAWINGS

The accompanying drawings, which are incorporated in and constitute a part of this specification, illustrate one or more embodiments described herein and, together with the Detailed Description, explain these embodiments. In the drawings:

FIG. 1 is a block diagram of an exemplary system for providing efficient communication between a computerized user device and a battery module using a serial communication protocol, in accordance with the present application;

FIG. 2 is a block diagram of a detailed view of the computerized user device of FIG. 1;

FIG. 3 is a block diagram of an exemplary battery manager controller included in the battery module of FIG. 1;

FIG. 4a illustrates the structure of an exemplary serial protocol command message usable in the communication between the computerized user device of FIG. 1 and the battery module of FIG. 1;

FIG. 4b illustrates the structure of an exemplary serial protocol response message usable in the communication between the computerized user device of FIG. 1 and the battery module of FIG. 1;

FIGS. 5a-5h are exemplary display screenshots of graphical user interfaces (GUIs) that can be presented on a display associated with the computerized user device of FIG. 1; and

FIG. 6 is a flow diagram of an exemplary method of operating the system of FIG. 1.

### DETAILED DESCRIPTION

Systems and methods are disclosed that provide for efficient communication between a computerized user device and a battery module using a serial communication protocol. The disclosed systems and methods employ a bootloader program that can be executed in response to commands issued by the computerized user device using the serial communication protocol, thereby allowing selected firmware programs to be downloaded into nonvolatile memory within the battery module and subsequently executed for performing desired functions relating to design, manufacture, testing, and/or maintenance of the battery module for a range of target battery applications.

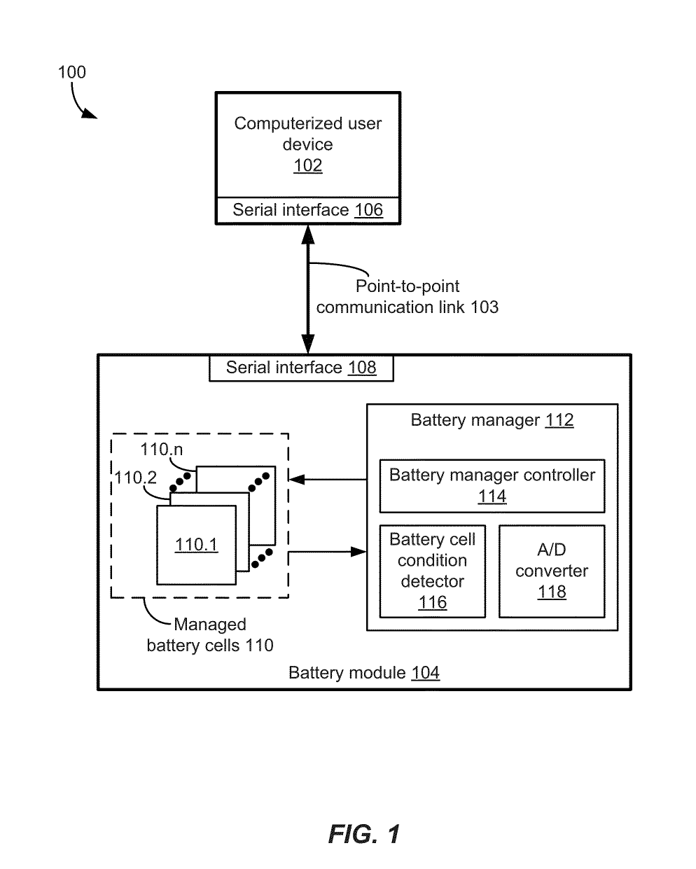

FIG. 1 depicts an illustrative embodiment of an exemplary system 100 for communicably connecting a computerized user device to a battery module, in accordance with the present application. As shown in FIG. 1, the system 100 includes a computerized user device 102, a battery module 104, and a point-to-point communication link 103 communicably connecting the computerized user device 102 with the battery module 104. The battery module 104 includes one or more managed battery cells 110.1-110.n, a serial port interface 108, and a battery manager 112, which, in turn, can include a battery manager controller 114, a battery cell condition detector 116, and an analog-to-digital (A/D) converter 118. The computerized user device 102 likewise includes a serial port interface 106.

For example, the point-to-point communication link 103 can be implemented as a universal asynchronous receiver-transmitter (UART) bus, a control area network (CAN) bus, a universal serial bus (USB), a system management bus (SMBus), or any other suitable point-to-point communication link. Further, the serial port interfaces 106 and 108 can each be implemented as a diagnostic data link (DDL) UART transceiver, a CAN transceiver, a USB transceiver, an SMBus transceiver, or any other suitable serial interface for interfacing the computerized user device 102 or the battery module 104 with the point-to-point communication link 103. The respective serial port interfaces 106, 108 are configured to allow the battery module 104 to participate in a two-way, half duplex communication with the computerized user device 102 over the point-to-point communication link 103.

It is noted that the managed battery cells 110.1-110.n can be connected in series and/or in parallel within the battery module 104, as required and/or desired, for a particular target battery application. For example, the managed battery cells 110.1-110.n can be configured and arranged as described in co-pending U.S. patent application Ser. No. 14/482,156 filed Sep. 10, 2014 entitled CONTROL METHOD FOR DISCONNECTING SWITCHES INTEGRATED IN SERIES-CONNECTED BATTERIES. Further, the batteries included in the managed battery cells 110.1-110.n can be lithium-ion batteries or any other suitable batteries.

It is further noted that the battery cell condition detector 116 within the battery manager 112 can include a temperature sensor (e.g., a thermocouple) for sensing the temperature of a respective battery cell (such as the managed battery cell 110.1, 110.2, . . . , or 110.n), as well as a temperature sensing circuit for generating an indication of a detected battery cell condition, such as the condition in which the respective battery cell either has its temperature exceed a preset limit or experiences thermal runaway. The battery cell condition detector 116 can further include, in place of or in addition to the temperature sensor, any other suitable sensor(s) and/or circuitry (e.g., voltage sensor(s), current sensor(s)) for sensing various operating conditions, fault conditions, and/or non-fault conditions among the managed battery cells 110. The A/D converter 118 is operative to convert the sensed operating conditions, fault conditions, and/or non-fault conditions associated with the managed battery cells 110 from analog form to digital form for subsequent use by the battery manager controller 114, as well as subsequent transmission from the battery module 104 to the computerized user device 102 over the point-to-point communication link 103. In an alternative embodiment, such sensed operating conditions, fault conditions, and/or non-fault conditions can be transmitted in digital form from the battery module 104 to the computerized user device 102 over a CAN bus, an SMBus, or any other suitable bus.

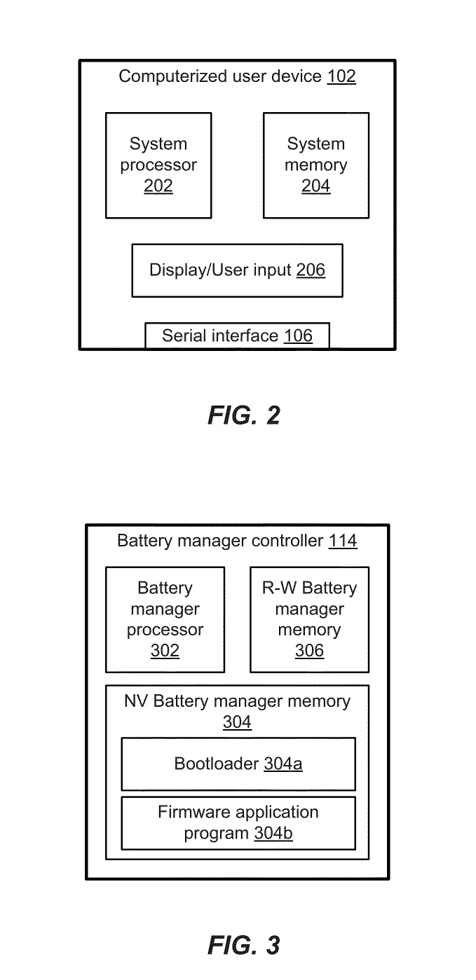

FIG. 2 depicts a detailed view of the computerized user device 102 of FIG. 1. As shown in FIG. 2, the computerized user device 102 includes a system processor 202, a system memory 204, and a display/user input 206, as well as the serial port interface 106 for interfacing the computerized user device 102 with the point-to-point communication link 103. For example, the computerized user device 102 can be a personal computer, a laptop computer, a tablet computer, a smartphone, or any other suitable computerized user device. Further, the display/user input 206 of the computerized user device 102 can be configured as a liquid crystal diode (LCD) or light-emitting diode (LED) display with a touchscreen incorporated into the LCD or LED display, a keyboard and/or a mouse connected to the computerized user device 102 but separate from the LCD or LED display, or any other suitable display and user input mechanism(s).

FIG. 3 depicts a detailed view of the battery manager controller 114 within the battery manager 112 of FIG. 1. As shown in FIG. 3, the battery manager controller 114 includes a battery manager processor 302, a nonvolatile (NV) battery manager memory 304, and a read-write (R-W) battery manager memory 306. For example, the NV battery manager memory 304 can be implemented using flash memory, electrically erasable programmable read-only memory (EEPROM), and/or any other suitable nonvolatile memory. Further, the R-W battery manager memory 306 can be implemented using random access memory (RAM) or any other suitable read-write memory. The NV battery manager memory 304 is operative to store at least a bootloader program 304a and at least one firmware application program 304b. In one embodiment, the battery manager processor 302 is operative to execute a selected application program out of the NV battery manager memory 304 for performing design validation, calibration, simulation testing, and/or performance monitoring of the battery module 104. In an alternative embodiment, the battery manager processor 302 is operative to execute the selected application program out of the R-W battery manager memory 306 for performing such design validation, calibration, simulation testing, and/or performance monitoring of the battery module 104.

In an exemplary mode of operation, in response to at least one user input from the display/user input 206, the system processor 202 within the computerized user device 102 can execute a computer program out of the system memory 204 to select a firmware program, such as a firmware application program, stored in the system memory 204, and to send at least one command over the point-to-point communication link 103 to the battery module 104 using the serial communication protocol. In response to the command from the computerized user device 102, the battery manager processor 302 within the battery manager controller 114 can execute the bootloader program 304a out of the NV battery manager memory 304 to download the selected firmware application program over the point-to-point communication link 103 from the system memory 204 of the computerized user device 102 for storage in the NV battery manager memory 304 of the battery manager controller 114. The battery manager processor 302 can further execute the application program out of the NV battery manager memory 304 for performing design validation, calibration, simulation testing, and/or performance monitoring of the battery module 104. Alternatively, the battery manager processor 302 can further execute the bootloader program 304a out of the NV battery manager memory 304 to load the firmware application program 304b from the NV battery manager memory 304 to the R-W battery manager memory 306, and subsequently execute the application program out of the R-W battery manager memory 306 for performing such design validation, calibration, simulation testing, and/or performance monitoring of the battery module 104.

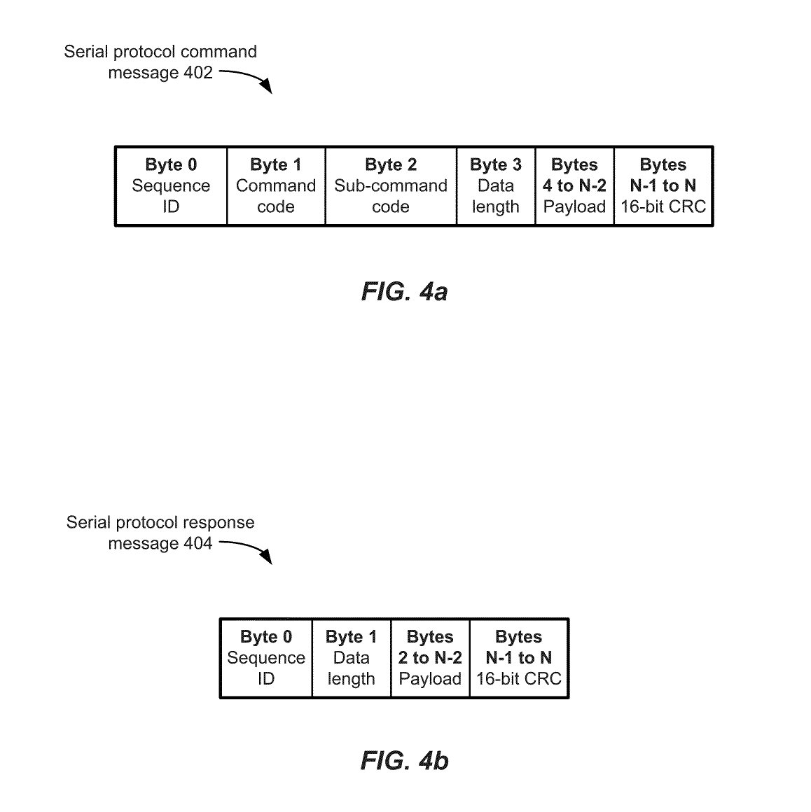

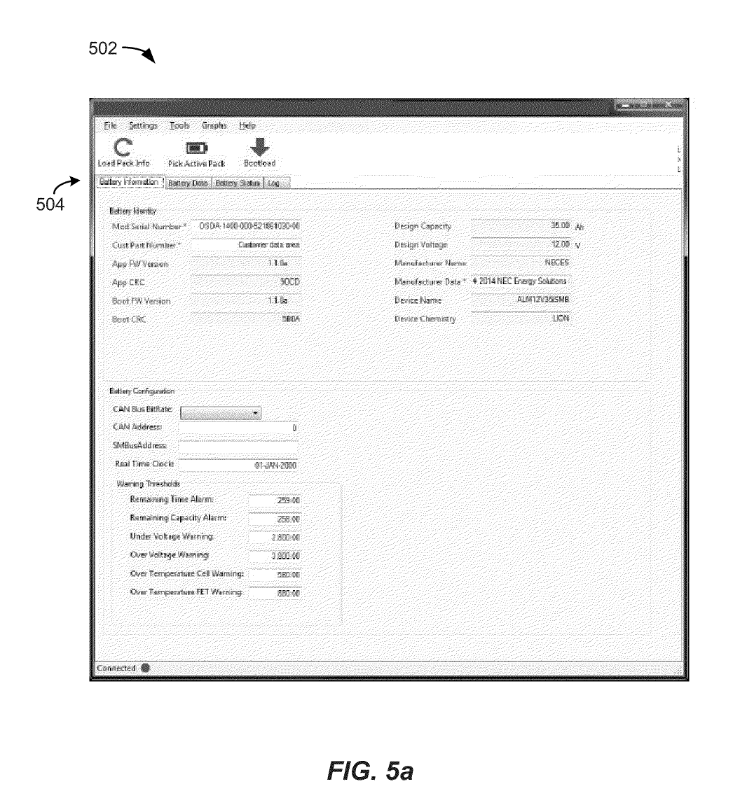

FIG. 4a illustrates the structure of an exemplary serial protocol command message 402 that can be used in the communication between the computerized user device 102 and the battery module 104 of FIG. 1. As shown in FIG. 4a, the serial protocol command message 402 is a packet having a multi-byte structure, in which byte “0” is a sequence identifier (ID), byte “1” is a command code, byte “2” is a sub-command code, byte “3” is the data length, bytes “4 to N−2” are the packet payload, and bytes “N−1 to N” are a multi-bit (e.g., a 16-bit) cyclic redundancy code (CRC). For example, in the command packet constituting the serial protocol command message 402, “N” can be equal to 255 bytes or any other suitable number of bytes.

The sequence ID in byte 0 of the command packet is a unique identifier for each serial protocol command message 402 sent by the computerized user device 102 to the battery module 104. The command code in byte 1 of the command packet is another unique identifier for a particular serial protocol command/response function pertaining to the design validation, calibration, simulation testing, and/or performance monitoring of the battery module 104. The sub-command code in byte 2 of the command packet can be used to categorize the data contained in the command packet, as well as to specify the direction of the data. For example, the most significant bit (MSB) or any other suitable bit of byte 2 of the command packet can be used to specify the data direction or read-write (R-W) property of the serial protocol command message 402. The data length in byte 3 of the command packet corresponds to the number of bytes of payload contained in the serial protocol command message 402. The packet payload in bytes 4 to N−2 of the command packet can include data pertaining to at least the transaction type, the data type, and/or the command code. The multi-bit CRC in bytes N−1 to N of the command packet is a cyclic redundancy code that can be calculated, generated, determined, or otherwise obtained for the data in bytes 0 to N−2 of the command packet. Such a cyclic redundancy code can be used to detect communication errors that might occur while sending the serial protocol command message 402 from the computerized user device 102 to the battery module 104.

FIG. 4b illustrates the structure of an exemplary serial protocol response message 404 that can be used in the communication between the computerized user device 102 and the battery module 104 of FIG. 1. Like the serial protocol command message 402 (see FIG. 4a), the serial protocol response message 404 (see FIG. 4b) is a packet having a multi-byte structure, in which byte “0” is the sequence ID, byte “1” is the data length, bytes “2 to N−2” are the packet payload, and bytes “N−1 to N” are a multi-bit (e.g., 16-bit) CRC. For example, in the response packet constituting the serial protocol response message 404, “N” can be equal to 255 bytes or any other suitable number of bytes.

The sequence ID in byte 0 of the response packet is the same unique identifier included in a corresponding command packet sent from the computerized user device 102 to the battery module 104 that is effectively echoed back in the response packet sent from the battery module 104 to the computerized user device 102. If the computerized user device 102 determines that the sequence ID in the response packet does not match the sequence ID in the corresponding command packet, then the computerized user device 102 can deem that response packet to be invalid. The MSB or any other suitable bit of the sequence ID of the response packet can be used to indicate an acknowledgment/negative acknowledgment (ACK/NAK) of the corresponding command packet. Further, a sequence ID of the form “0x00” in byte 0 of a response packet sent from the battery module 104 to the computerized user device 102 can indicate what is referred to herein as an “unsolicited broadcast packet”, which can be used by the battery module 104 to provide, on its own accord, system level information for the battery module 104 (e.g., the state of charge (SOC), the battery cell voltage(s), the battery cell current(s)), as well as the status of the battery module 104 (e.g., fault, alarm, and/or warning indication(s)), to the computerized user device 102 over the point-to-point communication link 103. The data length in byte 1 of the response packet corresponds to the number of bytes of payload contained in the serial protocol response message 404. The payload in bytes 2 to N−2 of the response packet can include data pertaining to at least the transaction type and/or the data type. For example, the payload in bytes 2 to N−2 of the response packet can include index values, temperature readings, voltage readings, current readings, data pertaining to one or more downloads of firmware programs, etc. The multi-bit CRC in bytes N−1 to N of the response packet is a cyclic redundancy code that can be calculated, generated, determined, or otherwise obtained for the data in bytes 0 to N−2 of the response packet. Such a cyclic redundancy code can be used to detect communication errors that might occur while sending the serial protocol response message 404 from the battery module 104 to the computerized user device 102.

In the disclosed systems and methods, the serial communication protocol for providing efficient communication between the computerized user device 102 and the battery module 104 is a master-slave protocol, in which the computerized user device 102 operates as the “master”, and the battery module 104 operates as the “slave”. Such a master-slave protocol can be designed as an asynchronous serial communication protocol for sending and receiving serial protocol command/response messages between the computerized user device 102 and the battery module 104 over the point-to-point communication link 103.

In one embodiment, the serial communications protocol defines a plurality of categories of command codes, including, but not limited to, system command codes, measurement command codes, and calibration command codes. The serial communications protocol further defines a plurality of sub-categories of data contained in the respective categories of command codes, such as system sub-command codes, measurement sub-command codes, and calibration sub-command codes. For example, the system sub-command codes can include, but are not limited to, system sub-commands pertaining to a battery module status, a bootloader program reset, a battery manager configuration, a broadcast status message enable/disable, and a simulation testing mode enable/disable. The measurement sub-command codes can include, but are not limited to, measurement sub-commands pertaining to a battery cell voltage, a battery cell current, a minimum battery cell voltage, a maximum battery cell voltage, a battery cell voltage index, a battery cell temperature index, a relative state of charge (SOC), an absolute SOC, a remaining capacity of a battery module, a full charge capacity of a battery module, and a battery module runtime to empty. The calibration sub-command codes can include, but are not limited to, calibration sub-commands pertaining to a calibration mode enable/disable, a calibration voltage clear index, a calibration voltage low index, a calibration voltage high index, a calibration current clear index, a calibration current low index, and a calibration current high index.

The disclosed system 100 for communicably connecting a computerized user device to a battery module will be further understood with reference to the following illustrative examples. In the following examples, the system processor 202 within the computerized user device 102 can present, on the display/user input 206, a plurality of graphical user interfaces (GUIs) to allow a user to select, define, set, and/or access one or more values, readings, parameters, and/or other information and/or data associated with one or more desired serial protocol command/response functions pertaining to the design validation, calibration, simulation testing, and/or performance monitoring of the battery module 104.

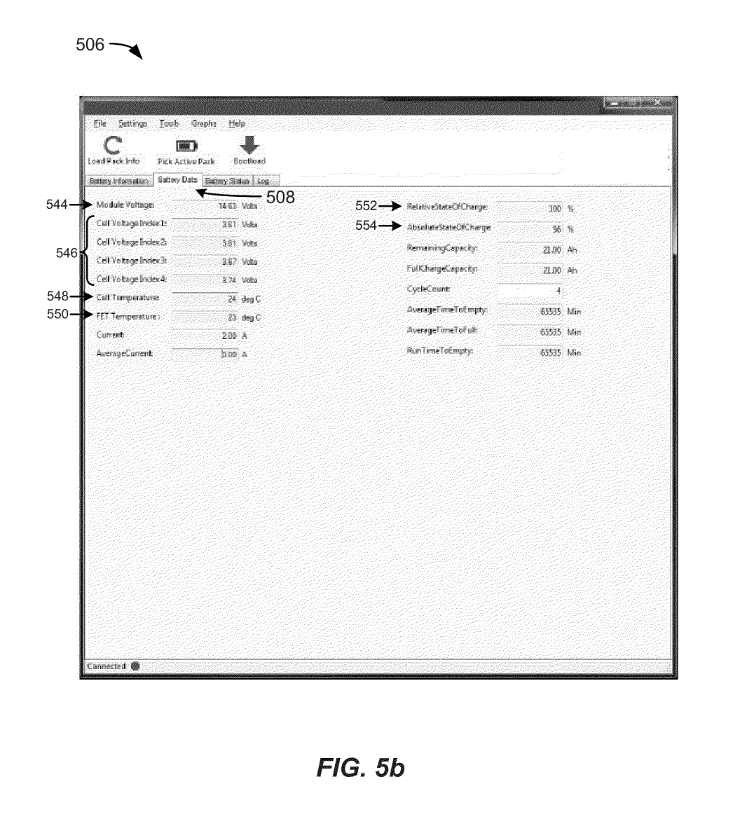

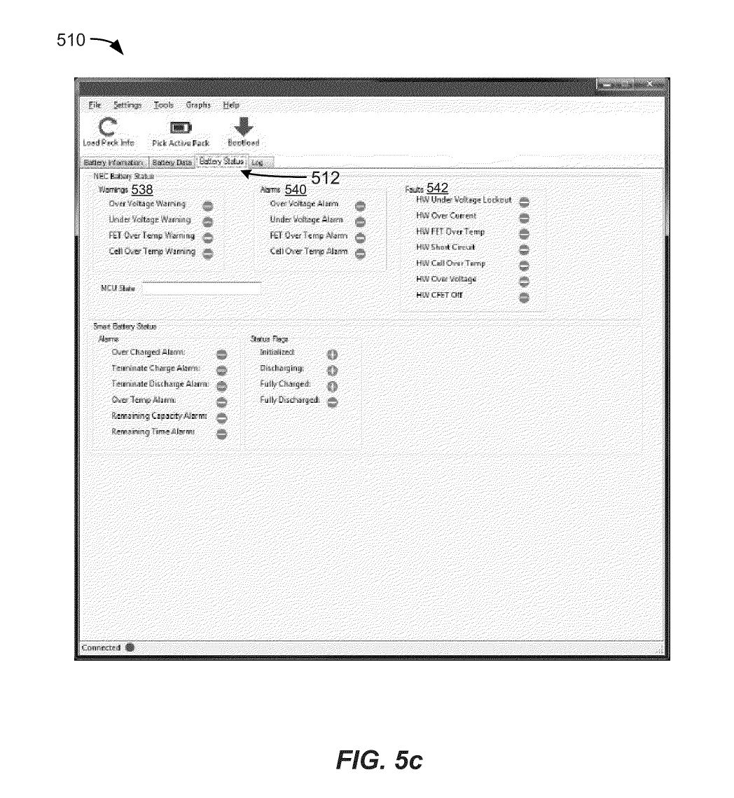

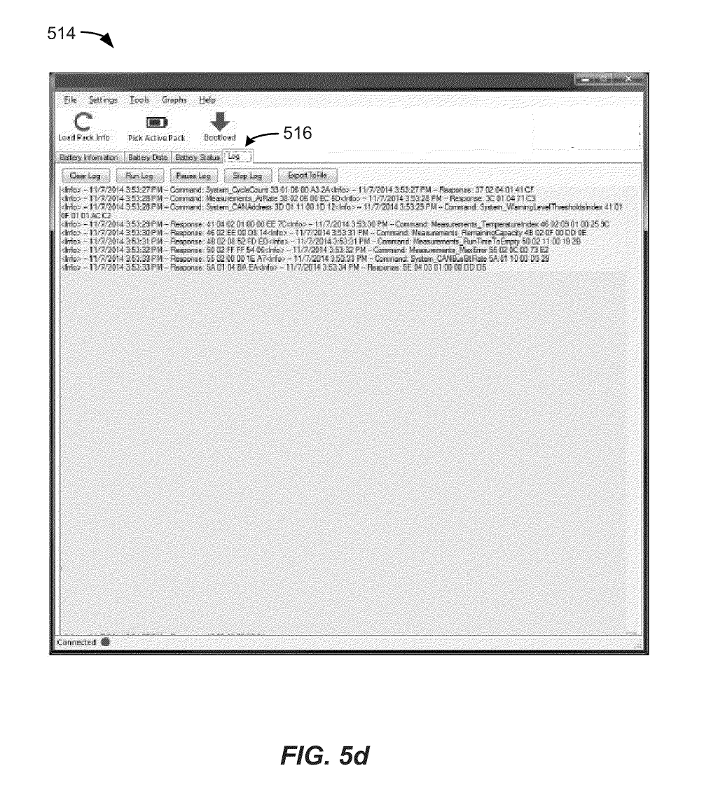

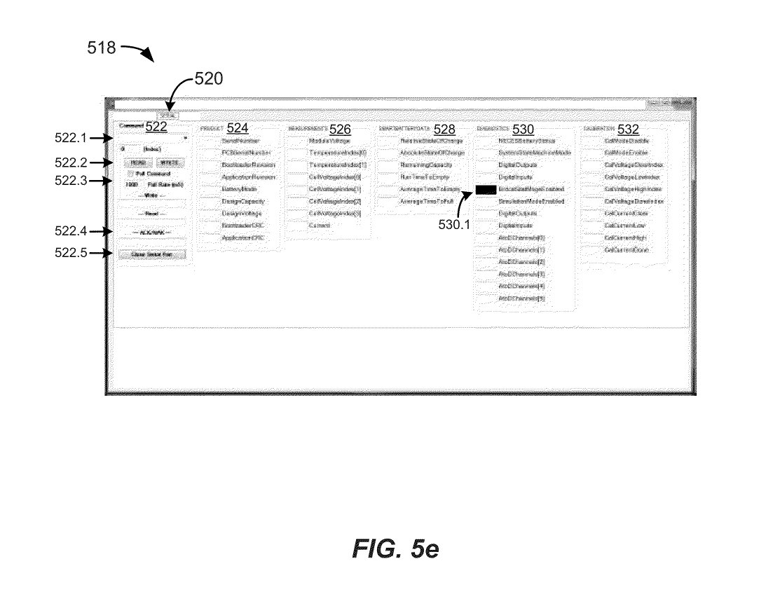

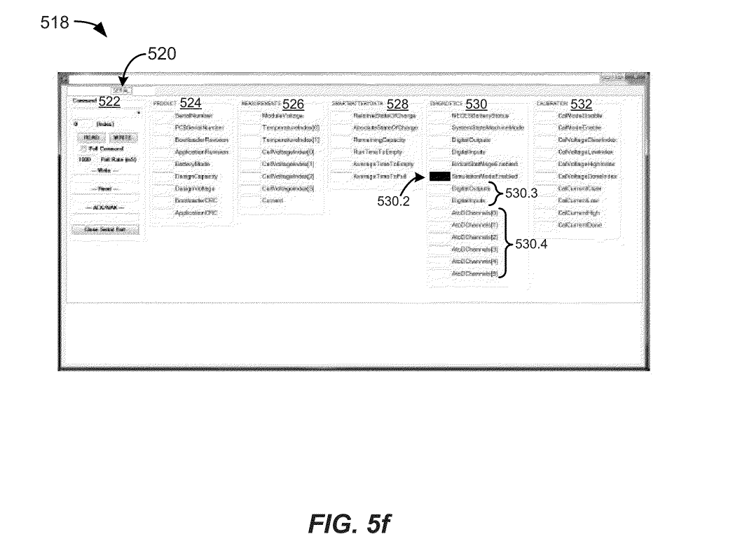

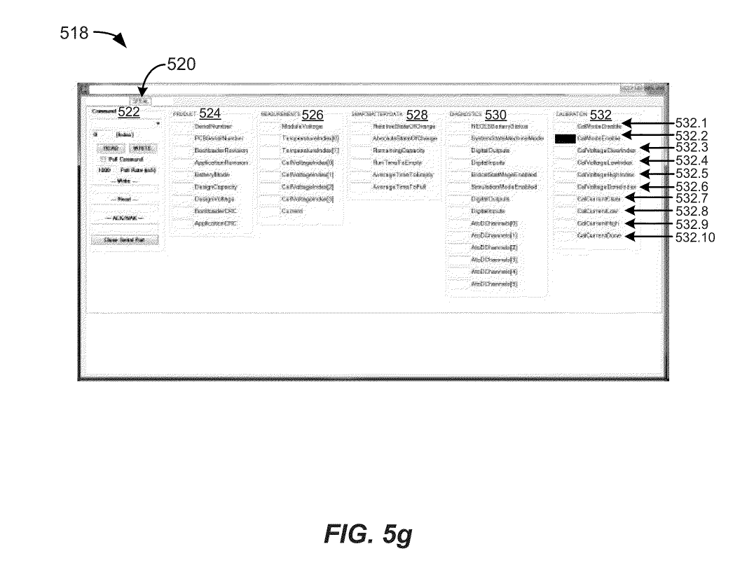

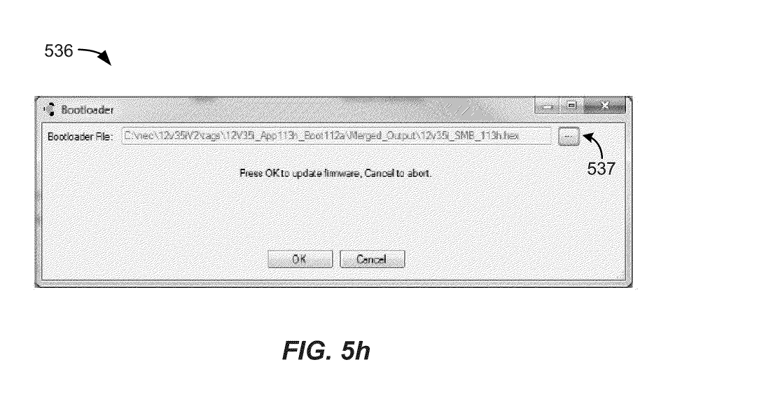

FIGS. 5a, 5b, 5c, and 5d depict several of such GUIs in a plurality of exemplary display screenshots 502, 506, 510, and 514, respectively. As depicted in FIG. 5a, the display screenshot 502 includes a first tab 504 for displaying battery information (e.g., battery identity, battery configuration) associated with the battery module 104. As depicted in FIG. 5b, the display screenshot 506 includes a second tab 508 for displaying battery data associated with one or more battery cells included in the battery module 104. As depicted in FIG. 5c, the display screenshot 510 includes a third tab 512 for displaying battery status information (e.g., warnings, alarms, faults, status flags) for the battery module 104. As depicted in FIG. 5d, the display screenshot 514 includes a fourth tab 516 for displaying a log of exemplary serial protocol command/response messages that can be sent between the computerized user device 102 and the battery module 104 over the point-to-point communication link 103.

With further regard to the following illustrative examples, the system processor 202 can execute at least one computer program out of the system memory 204 to send one or more serial protocol command messages to the battery module 104, in which each serial protocol command message includes a command packet. In response to the serial protocol command messages, the battery manager processor 302 within the battery manager controller 114 can execute an application program out of the NV battery manager memory 304 to send, as appropriate, one or more serial protocol response messages to the computerized user device 102, in which each serial protocol response message includes a response packet. In this way, the computerized user device 102 and the battery module 104 can communicate with each other, using the serial communication protocol, for implementing particular serial protocol command/response functions pertaining to the design validation, calibration, simulation testing, and/or performance monitoring of the battery module 104.

In a first illustrative example, the battery manager processor 302 within the battery manager controller 114 executes an engineering application program out of the NV battery manager memory 304, causing the system processor 202 within the computerized user device 102 to present a GUI pertaining to the execution of the engineering application program on the display/user input 206. FIGS. 5e-5g depict the GUI in an exemplary display screenshot 518, which includes a plurality of functional groupings relating to (1) entry of a serial protocol command 522, (2) product information 524 for the battery module 104 communicably connected to the computerized user device 102, (3) measurements 526 for a number of battery cells included in the battery module 104, (4) a smart battery configuration 528 for the battery module 104, (5) diagnostics 530 that can be performed on the battery module 104, and (6) calibration 532 of the battery module 104. As shown in FIG. 5e, the functional grouping relating to the entry of a serial protocol command 522 includes a field 522.1 for entering a serial protocol command message, a plurality of buttons 522.2 for use in specifying the read-write (R-W) property of the serial protocol command message, a utility 522.3 for use in specifying, as appropriate, the serial protocol command message as a poll command, a utility 522.4 for use in indicating an acknowledgment/negative acknowledgment (ACK/NAK) of the serial protocol command message from the battery module 104, and a button 522.5 for use in opening/closing the serial port interface 106.

In this first illustrative example, the field 522.1 within the functional grouping relating to the entry of a serial protocol command 522 can be used to enter a serial protocol command message for enabling an unsolicited broadcast status message function, thereby causing the battery module 104 to provide, on its own accord via one or more unsolicited broadcast packets, system level and/or status information to the computerized user device 102 over the point-to-point communication link 103. An indication of such enablement of the unsolicited broadcast status message function can be provided in a field 530.1 within the functional grouping relating to the diagnostics 530 for the battery module 104. Once the serial protocol command message is entered via the field 522.1, the system processor 202 can send, to the battery module 104, the serial protocol command message including a command packet containing a system command code and a system sub-command code pertaining to the enablement of the unsolicited broadcast status message function.

Having received the serial protocol command message from the computerized user device 102, the battery manager processor 302 can send, on its own accord, periodically or non-periodically to the computerized user device 102, one or more serial protocol response messages, in which each serial protocol response message includes an unsolicited broadcast packet containing a sequence ID of the form 0x00, as well as a payload including information and/or data pertaining to a battery status (e.g., warnings, alarms, faults, status flags), a state of charge (SOC), one or more battery cell voltages, one or more battery cell currents, etc. Having received such a serial protocol response message from the battery module 104, the computerized user device 102 can present, on the display/user input 206, at least one GUI to allow the user to access the information and/or data contained in the unsolicited broadcast packet.

For example, to access the information and/or data contained in an unsolicited broadcast packet, the user can select the second tab 508 included in the display screenshot 506 (see FIG. 5b) to display battery information and/or data such as the battery module voltage 544, the voltage indices 546 for a number of battery cells included in the battery module 104, the battery cell temperature 548, the temperature 550 of one or more metal-oxide substrate field effect transistor (MOSFET) switches used to control the operation of the battery module 104, the relative/absolute state-of-charge 552, 554 of the battery module 104, etc., such battery information and/or data being accessed from the unsolicited broadcast packet received from the battery module 104. The user can further select the third tab 512 included in the display screenshot 510 (see FIG. 5c) to display information and/or data pertaining to the battery status such as certain warnings 538, alarms 540, faults 542, etc., that might be issued by the battery module 104 through one or more of the unsolicited broadcast packets. At a desired time, the field 522.1 within the functional grouping relating to the entry of a serial protocol command 522 included in the display screenshot 518 (see FIG. 5e) can be used to enter a serial protocol command message for disabling the unsolicited broadcast status message function, thereby preventing further unsolicited broadcast status messages from being sent by the battery module 104 to the computerized user device 102 over the point-to-point communication link 103.

In a second illustrative example, the battery manager processor 302 within the battery manager controller 114 further executes the engineering application program out of the NV battery manager memory 304, causing the system processor 202 within the computerized user device 102 to present the GUI depicted in the display screenshot 518 (see FIG. 5f) on the display/user input 206. In this second example, the field 522.1 within the functional grouping relating to the entry of a serial protocol command 522 can be used to enter a serial protocol command message to cause the battery module 104 to enter a simulation testing mode of operation. Once the serial protocol command message is entered via the field 522.1, the system processor 202 can send, to the battery module 104, the serial protocol command message including a command packet containing a system command code and a system sub-command code pertaining to the enablement of a simulation testing mode function. An indication of such enablement of the simulation testing mode function can be provided in a field 530.2 (see FIG. 5f) within the functional grouping relating to the diagnostics 530 for the battery module 104.

Once the simulation testing mode function is enabled, the user can specify certain values, readings, and/or parameters associated with the operation of the battery module 104 that he or she wishes to be involved in the simulation mode testing. For example, to specify such values, readings, and/or parameters associated with the operation of the battery module 104, the user can employ one or more fields 530.3 associated with certain digital inputs/outputs of the battery module 104, as well as one or more fields 530.4 associated with certain A/D values involved in the operation of the battery module 104, as depicted in the display screenshot 518 (see FIG. 5f). The system processor 202 can send, to the battery module 104, a serial protocol command message that includes a command packet containing a system command code and a system sub-command code pertaining to the enablement of the simulation testing mode function. In one embodiment, the command packet can further contain a payload that includes a timeout value for the simulation testing mode function, which can subsequently be used at the battery module 104 to prevent the simulation testing mode function from inadvertently being enabled for an indefinite period of time.

Having received the serial protocol command message including the timeout value from the computerized user device 102, the battery manager processor 302 can enter the simulation testing mode of operation, and send, to the computerized user device 102, a serial protocol response message that includes a response packet containing a payload indicating the remaining amount of time for the simulation testing mode function. Once the battery module 104 has entered the simulation testing mode of operation, the system processor 202 can further send, to the battery module 104, one or more serial protocol command messages that include command packets containing measurement command codes and measurement sub-command codes pertaining to the battery module voltage, the voltage(s) and/or current(s) corresponding to one or more battery cell measurement channels, the relative/absolute SOCs, etc.

Having received the respective serial protocol command messages from the computerized user device 102, the battery manager processor 302 can send, to the computerized user device 102, one or more serial protocol response messages that include response packets containing payloads with information and/or data pertaining to the battery module voltage, the voltage(s)/current(s) corresponding to the battery cell measurement channel(s), the relative/absolute SOCs, etc., in accordance with the specifications made by the user at the display/user input 206 via the GUI depicted in the display screenshot 518 (see FIG. 5f). As described herein, the user can access such information and/or data contained in the payloads of the respective response packets at the display/user input 206, e.g., via at least the GUI depicted in the display screenshot 506 (see FIG. 5b). At a desired time, the field 522.1 within the functional grouping relating to the entry of a serial protocol command 522 depicted in the display screenshot 518 (see FIG. 5e) can be used to enter a serial protocol command message for disabling the simulation testing mode function. Alternatively, the user can allow the simulation testing mode function to terminate automatically at the end of the specified timeout period.

In a third illustrative example, the battery manager processor 302 within the battery manager controller 114 further executes the engineering application program out of the NV battery manager memory 304, causing the system processor 202 within the computerized user device 102 to present the GUI depicted in the display screenshot 518 (see FIG. 5g) on the display/user input 206. In this third example, the field 522.1 within the functional grouping relating to the entry of a serial protocol command 522 can be used to enter a serial protocol command message to cause the battery module 104 to enter a calibration mode of operation, for use in calibrating one or more circuits within the battery module 104 involved in the charging, testing, and/or monitoring of the managed battery cells 110.

For example, the user may employ the calibration mode of operation to correct tracking errors that can develop between circuitry used to provide the relative and/or absolute SOC of the battery module 104 (such circuitry is commonly referred to as the “fuel gauge circuitry”) and the managed battery cells 110 over multiple charge/discharge cycles. Such fuel gauge circuitry can be incorporated into the battery cell condition detector 116 included in the battery manager 112. Further, such fuel gauge circuitry can be configured to calculate the relative/absolute SOC of the battery module 104 based, at least in part, on the difference between specified calibration voltage high and low index values, as well as the difference between specified calibration current high and low index values. It is noted that fields 532.3-532.10 within the functional grouping relating to the calibration 532 of the battery module 104, as depicted in the display screenshot 518 (see FIG. 5g), can be used to specify a battery cell voltage clear index value, a battery cell voltage low index value, a battery cell voltage high index value, a battery cell voltage done index, a battery cell current clear index value, a battery cell current low index value, a battery cell current high index value, a battery cell current done index, respectively, for use in performing a calibration mode function.

Once the serial protocol command message is entered via the field 522.1, the system processor 202 can send, to the battery module 104, a serial protocol command message that includes a command packet containing a calibration command code and a calibration sub-command code pertaining to the enablement of the calibration mode function. Having received the serial protocol command message from the system processor 202, the battery manager processor 302 causes the battery module 104 to enter the calibration mode of operation. An indication of such enablement of the calibration mode function can be provided in a field 532.2 within the functional grouping relating to the calibration 532 of the battery module 104, as depicted in the display screenshot 518 (see FIG. 5g).

Once the battery module 104 enters the calibration mode of operation, the system processor 202 can send, to the battery module 104, a serial protocol command message that includes a command packet containing a calibration command code and a calibration sub-command code pertaining to the specified calibration voltage clear index value. Having received the serial protocol command message from the system processor 202, the battery manager processor 302 clears internal settings of both the calibration voltage high index value and the calibration voltage low index value for a particular battery cell measurement channel involved in the calibration. Next, the system processor 202 sends, to the battery module 104, a serial protocol command message that includes a command packet containing a calibration command code and a calibration sub-command code pertaining to the calibration voltage low index, as well as a payload indicating the specified value of the calibration voltage low index. In likewise fashion, the system processor 202 sends, to the battery module 104, a serial protocol command message that includes a command packet containing a calibration command code and a calibration sub-command code pertaining to the calibration voltage high index, as well as a payload indicating the specified value of the calibration voltage high index.

Having received the serial protocol command messages that include the command packets containing the payloads with the specified values of the calibration voltage high and low indices, the battery manager processor 302 can internally set the specified values of the calibration voltage high and low indices, and send, to the computerized user device 102, a serial protocol response message that includes a response packet confirming the successful completion of the settings of the calibration voltage high/low index values. An indication of such successful completion of the settings of the calibration voltage high/low index values can be provided in a field 532.6 within the functional grouping relating to the calibration 532 of the battery module 104, as depicted in the display screenshot 518 (see FIG. 5g).

It is noted that the system processor 202 can, in a similar fashion, cause the battery module 104 to calibrate the fuel gauge circuitry used to measure the current for the particular battery cell measurement channel, thereby internally setting the specified values of the calibration current high and low indices. At a desired time, the system processor 202 can send, to the battery module 104, a serial protocol command message that includes a command packet containing a calibration command code and a calibration sub-command code pertaining to the disablement of the calibration mode function. Having received the serial protocol command message from the system processor 202, the battery manager processor 302 causes the battery module 104 to exit the calibration mode of operation. An indication of such disablement of the calibration mode function can be provided in a field 532.1 within the functional grouping relating to the calibration 532 of the battery module 104, as depicted in the display screenshot 518 (see FIG. 5g).

In a fourth illustrative example, the system processor 202 within the computerized user device 102 can present, on the display/user input 206, a GUI to allow the user to select a firmware program (e.g., a bootloader program, a firmware application program) stored in the system memory 204 for updating the firmware program in the NV battery manager memory 304 of the battery manager controller 114. FIG. 5h depicts such a GUI in an exemplary display screenshot 536, which includes a button and field 537 for use in selecting the firmware program (e.g., a bootloader file, a firmware application file) from the system memory 204 of the computerized user device 102.

Having selected the firmware program (e.g., the firmware application file) from the system memory 204, the system processor 202 sends, to the battery module 104, a serial protocol command message that includes a command packet containing a system command code and a system sub-command code pertaining to the bootloader program reset, thereby placing the system 100 into a bootloader mode of operation. Having received the serial protocol command message from the system processor 202, the battery manager processor 302 causes the battery module 104 to enter the bootloader mode of operation, and sends, to the computerized user device 102, a serial protocol response message that includes a response packet confirming the entry into the bootloader mode of operation.

After the battery module 104 has entered the bootloader mode of operation, the system processor 202 sends, to the battery module 104, a serial protocol command message that includes a command packet containing a system command code and a system sub-command code for directing the battery manager processor 302 to execute the bootloader program 304a for the purpose of downloading, over the point-to-point communication link 103, the selected firmware application file from the system memory 204 to the NV battery manager memory 304. Once the selected firmware application file is downloaded into the NV battery manager memory 304, the battery manager processor 302 can further execute the bootloader program 304a to calculate a cyclic redundancy code (CRC) on the firmware application file data to assure that the application file was not corrupted while being downloaded over the point-to-point communication link 103.

Having downloaded the selected firmware application file, the battery manager processor 302 can execute the bootloader program 304a to reset the battery manager processor 302, to load the firmware application program contained in the firmware application file from the NV battery manager memory 304 to the R-W battery manager memory 306, and/or to terminate the bootloader mode of operation. The battery manager processor 302 can subsequently execute the application program (such as the engineering application program described herein with reference to the first, second, and third illustrative examples, or any other suitable application program) out of the NV battery manager memory 304 (or the R-W battery manager memory 306) for performing design validation, calibration, simulation testing, and/or performance monitoring of the battery module.

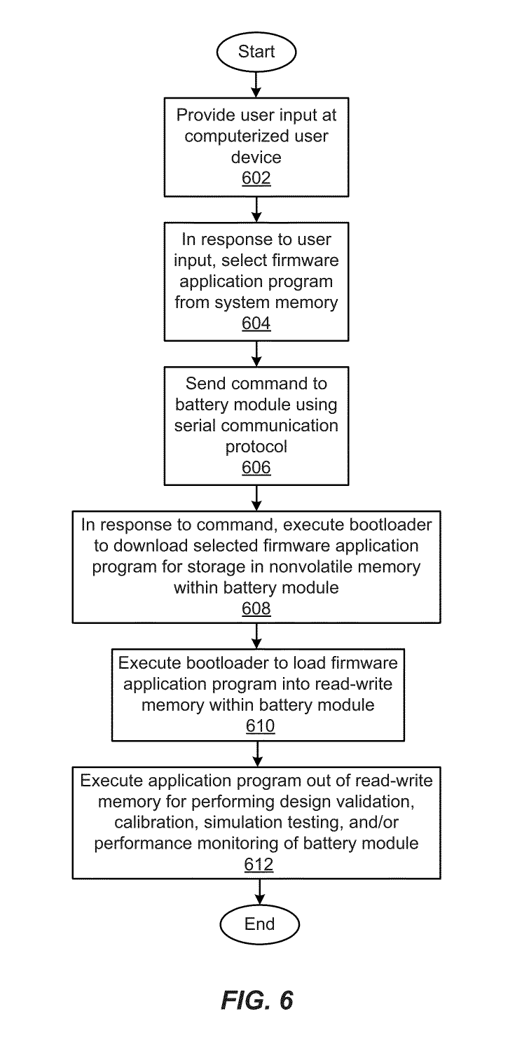

An exemplary method of operating the disclosed system 100 for communicably connecting a computerized user device to a battery module is described below with reference to FIGS. 1-3 and 6. As depicted in block 602 (see FIG. 6), a user input is provided at the display/user input 206 (see FIG. 2) of the computerized user device 102 (see FIGS. 1 and 2). As depicted in block 604, in response to the user input, a firmware program, such as a firmware application program, is selected from the system memory 204 of the computerized user device 102. As depicted in block 606, a command is sent from the computerized user device 102 to the battery module 104 (see FIG. 1) using the serial communication protocol. As depicted in block 608, in response to the command, a bootloader program 304a (see FIG. 3) is executed to download the selected firmware application program from the system memory 204 for storage in the NV battery manager memory 304 (see FIG. 3) within the battery manager controller 114 (see FIGS. 1 and 3), and for subsequent execution out of the NV battery manager memory 304. Alternatively, as depicted in block 610, the bootloader program 304a can be further executed to load the firmware application program 304b (see FIG. 3) into the R-W battery manager memory 306 of the battery manager controller 114 for subsequent execution out of the R-W battery manager memory 306. As depicted in block 612, the application program can then be executed out of the R-W battery manager memory 306 for performing design validation, calibration, simulation testing, and/or performance monitoring of the battery module 104.

It will be appreciated by those of ordinary skill in the art that modifications to and variations of the above-described systems and methods may be made without departing from the inventive concepts disclosed herein. Accordingly, the invention should not be viewed as limited except as by the scope and spirit of the appended claims.

What is claimed is:

1. A battery module communicably connectable to a computerized user device over a point-to-point communication link, the battery module comprising:
one or more battery cells;
a serial communication port interface configured to interface with the point-to-point communication link; and
a battery manager including a processor and a nonvolatile (NV) memory, the NV memory being operative to store at least a bootloader program,
wherein the processor is operative, in response to receipt of at least one command from the computerized user device:
to enter a bootloader mode of operation;
to send a response to the computerized user device to confirm entry into the bootloader mode of operation; and
to execute the bootloader program to download, over the point-to-point communication link, a selected firmware program from the computerized user device for storage in the NV memory, and
wherein the processor is further operative to receive the at least one command from the computerized user device, and to send the response to the computerized user device, using a serial communication protocol.

2. The battery module of claim 1 wherein the selected firmware program is an application program, and wherein the processor is further operative to execute the application program out of the NV memory for performing one or more of design validation, calibration, simulation testing, and performance monitoring of the battery module.

3. The battery module of claim 1 wherein the serial communication port interface is one of a diagnostic data link (DDL) universal asynchronous receiver-transmitter (UART) transceiver, a control area network (CAN) transceiver, a universal serial bus (USB) transceiver, and a system management bus (SMBus) transceiver.

4. The battery module of claim 1 wherein the at least one command corresponds to at least one serial protocol command message, the serial protocol command message being configured as a packet having a multi-byte structure.

5. The battery module of claim 4 wherein the multi-byte structure includes two or more of a first byte for a sequence identifier (ID), a second byte for a command code, a third byte for a sub-command code, a fourth byte for a data length, a first plurality of bytes for a packet payload, and a second plurality of bytes for a cyclic redundancy code (CRC).

6. The battery module of claim 1 wherein the response corresponds to a serial protocol response message, the serial protocol response message being configured as a packet having a multi-byte structure.

7. The battery module of claim 6 wherein the multi-byte structure includes two or more of a first byte for a sequence identifier (ID), a second byte for a data length, a first plurality of bytes for a packet payload, and a second plurality of bytes for a cyclic redundancy code (CRC).

8. The battery module of claim 1 wherein the serial communication protocol is a master-slave protocol.

9. The battery module of claim 8 wherein the master-slave protocol is an asynchronous serial communication protocol.

10. A method of communicably connecting a battery module to a computerized user device over a point-to-point communication link, comprising:
receiving, at the battery module using a serial communication protocol, at least one command from the computerized user device, the battery module including one or more battery cells, a serial communication port interface for interfacing with the point-to-point communication link, and a battery manager including a processor and a nonvolatile (NV) memory;
in response to the at least one command from the computerized user device:
entering, at the processor, a bootloader mode of operation;
sending, by the processor using the serial communication protocol, a response to the computerized user device to confirm entry into the bootloader mode of operation; and
executing, by the processor, the bootloader program for downloading, over the point-to-point communication link, a selected firmware program from the computerized user device; and
storing the selected firmware program in the NV memory.

11. The method of claim 10 wherein the selected firmware program is an application program, and wherein the method further comprises:
executing, by the processor, the application program out of the NV memory for performing one or more of design validation, calibration, simulation testing, and performance monitoring of the battery module.

12. The method of claim 11 wherein the executing of the application program includes performing, by the processor, an unsolicited broadcast status message function that includes sending, on accord of the processor, one or more serial protocol response messages to the computerized user device, each serial protocol response message including an unsolicited broadcast packet containing information pertaining to at least a status of the battery module.

13. The method of claim 11 wherein the executing of the application program includes performing, by the processor, a simulation testing mode function that includes:
receiving, at the processor, one or more serial protocol command messages that include command packets containing measurement command codes pertaining to one or more of a voltage of the battery module, at least one voltage associated with at least one of the battery cells, at least one current associated with at least one of the battery cells, and a state-of-charge of the battery module; and
sending, by the processor to the computerized user device, one or more serial protocol response messages that include response packets containing information pertaining to one or more of the voltage of the battery module, the at least one voltage associated with at least one of the battery cells, the at least one current associated with at least one of the battery cells, and the state-of-charge of the battery module.

14. The method of claim 13 further comprising:
providing user specifications for the simulation testing mode function; and
obtaining, by the processor, the information pertaining to one or more of the voltage of the battery module, the at least one voltage associated with at least one of the battery cells, the at least one current associated with at least one of the battery cells, and the state-of-charge of the battery module, in accordance with the user specifications for the simulation testing mode function.

15. The method of claim 11 wherein the executing of the application program includes performing, by the processor, a calibration mode function that includes:
receiving, at the processor, one or more serial protocol command messages that include command packets containing calibration command codes, at least one of the command packets containing a predetermined value of a calibration voltage or current low index, and at least one of the command packets containing a predetermined value of a calibration voltage or current high index; and
having received the calibration command codes, performing, by the processor, one or more of:
clearing internal settings of one or more calibration voltage or current index values;
internally setting a calibration voltage or current low index to the predetermined value of the calibration voltage or current low index; and
internally setting a calibration voltage or current high index to the predetermined value of the calibration voltage or current high index.

16. A system for communicably connecting a computerized user device to a battery module over a point-to-point communication link, the system comprising:
a battery module including:
one or more battery cells;
a first serial communication port interface configured to interface with the point-to-point communication link; and
a battery manager including a battery manager processor and a nonvolatile (NV) memory, the NV memory being operative to store at least a bootloader program, and
a computerized user device including:
a second serial communication port interface configured to interface with the point-to-point communication link;
a system processor; and
a system memory,
wherein the system processor within the computerized user device is operative:
in response to at least one user input, to select a firmware program stored in the system memory; and
to send, using a serial communication protocol, at least one command to the battery module over the point-to-point communication link,
wherein the battery manager processor within the battery module is operative, in response to the at least one command:
to enter a bootloader mode of operation;
to send, using the serial communication protocol, a response to the computerized user device to confirm entry into the bootloader mode of operation; and
to execute the bootloader program to download, over the point-to-point communication link, the selected firmware program from the computerized user device, and
wherein the battery manager processor within the battery module is further operative to store the selected firmware program in the NV memory.

17. The system of claim 16 wherein the battery manager processor within the battery module is further operative:
to execute the application program out of the NV memory for performing, with respect to the battery module, one or more of a design validation function, a calibration mode function, a simulation testing mode function, and a performance monitoring function.

18. The system of claim 17 wherein the computerized user device includes a display and user input mechanism operative to provide at least one graphical user interface (GUI) for use in enabling one or more of the design validation function, the calibration mode function, the simulation testing mode function, and the performance monitoring function.

19. The system of claim 17:
wherein the system processor within the computerized user device is further operative to send, to the battery module, one or more serial protocol command messages that include command packets containing measurement command codes pertaining to one or more of a voltage of the battery module, at least one voltage corresponding to at least one of the battery cells, at least one current corresponding to at least one of the battery cells, and a state-of-charge of the battery module; and
wherein the battery manager processor within the battery module is further operative, in response to the serial protocol command messages, to send, to the computerized user device, one or more serial protocol response messages that include response packets containing information pertaining to one or more of the voltage of the battery module, the at least one voltage corresponding to at least one of the battery cells, the at least one current corresponding to at least one of the battery cells, and the state-of-charge of the battery module.

20. The system of claim 19 wherein the computerized user device includes a display and user input mechanism operative to provide at least one graphical user interface (GUI) for use in accessing the information pertaining to one or more of the voltage of the battery module, the at least one voltage corresponding to at least one of the battery cells, the at least one current corresponding to at least one of the battery cells, and the state-of-charge of the battery module contained in the response packets.
